(19) United States
(12) Patent Application Publication
(10) Pub. No.: US 2007/0272764 A1
(43) Pub. Date: Nov. 29, 2007

(54) Fluid Product Spraying Device

(76) Inventor: Fabien Poulard, Rouen (FR)

Correspondence Address: SUGHRUE MION, PLLC, 2100 PENNSYLVANIA AVENUE, N.W., SUITE 800, WASHINGTON, DC, 20037, US

(21) Appl. No.: 10/577,850

(22) PCT Filed: Oct. 26, 2004
(86) PCT No.: PCT/FR04/50535

§ 371 Date: May 24, 2007

(30) Foreign Application Priority Data
Oct. 28, 2003 (FR) 0312587

(51) Int. Cl. G01F 15/06

(52) U.S. Cl. 239/71

(57) ABSTRACT

A fluid product spray device comprising a fluid product distribution pump (10) and a spray head (20) for manually actuating the pump (10). The device comprises distribution detection means (30) which are used to detect the distribution of a dose of product, said detection means (30) being adapted in such a way as to be able to provide a signal informing the user that a dose of product has been distributed by said pump.

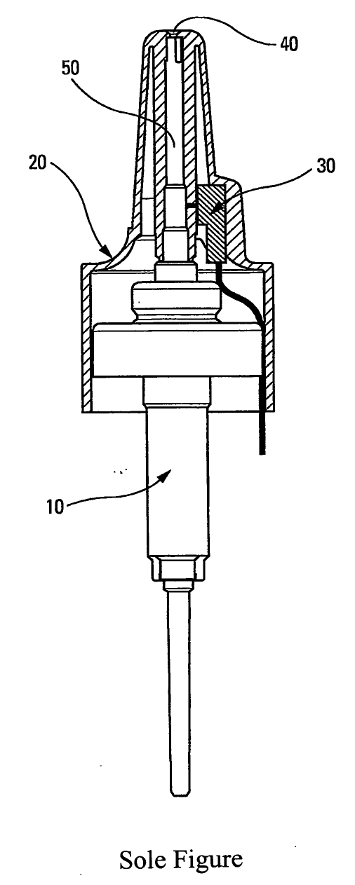

This invention relates to a fluid product spraying device, and particularly such a device comprising a manually actuated pump.

It is known that pumps or valves can be used to dispense fluid product (liquid, cream or powder) in a measured manner, particularly in the pharmaceutical, perfume and cosmetic fields. In particular, it may be very important in the pharmaceutical field to avoid any risk of overdosage. For a valve operating with a propellant gas, the problem is applicable particularly to counting emitted doses, and it is frequently necessary to avoid any risk of under-counting to ensure that the user does not have an empty device while believing that he still has a few doses left to be dispensed. For valves operating with a propellant gas, when the product is dispensed, it is propelled at high pressure by the said propellant gas, and the user is clearly aware that the product is dispensed. However if a pump is used, and particularly new generation pumps, spraying may be so fine that the user does not always realise that the dose has been dispensed. This is true particularly with some nasal dispensing pumps. In this case, if the user is not given any indication to inform him that the dose has actually been dispensed, there is a risk that he will press the device again, thinking that the first action was ineffective. This introduces a risk of overdosage, which can be dangerous for health.

The purpose of this invention is to provide a fluid product spraying device that does not have the above mentioned disadvantages.

In particular, the purpose of this invention is to provide a fluid product spraying device comprising a pump in which there is no risk of overdosage.

Another purpose of this invention is to provide such a device that is simple and inexpensive to make and to assemble and is safe and reliable in use.

Therefore, the purpose of this invention is a fluid product spraying device comprising a fluid product dispensing pump and a spray head to actuate the said pump manually, the said device comprising dispensing detection means to detect dispensing of a product dose, the said detection means being adapted to output a signal to inform the user that a dose of product has actually been dispensed by the said pump.

Advantageously, the dispensing pump is connected to a spraying orifice through an expulsion channel, the said detection means being provided in the said expulsion channel.

Advantageously, the said detection means comprise an expulsion detector adapted to detect passage of the product in the said expulsion channel.

Advantageously, the said expulsion detector comprises a pressure sensor adapted to detect the pressure difference at the time of spraying a product dose.

Advantageously, the said detection means are connected to electronic means to process signals output by the said detection means.

Advantageously, the said detection means are also adapted to increment or decrement a dose counter.

Advantageously, the said device is a nasal spraying device, the said pump being adapted to dispense the product so finely sprayed that this spraying is undetectable by the user, the said detection means informing the user each time that a product dose has been dispensed.

Advantageously, the said pump operates without propellant gas and/or without active spraying means such as piezoelectric or electrostatic spraying means.

Other characteristics and advantages of this invention will become clearer after reading the following detailed description of an advantageous embodiment of the invention with reference to the single FIGURE attached given as a non-limitative example, which diagrammatically shows a cross-section through a spraying device according to one particular embodiment of this invention.

This FIGURE shows a pump 10 provided with a spray head 20. The pump may be of any type, and the internal structure of this pump will therefore not be described in more detail below. However, this invention is applicable in particular to dispensing pumps that dispense a very fine sprayed dose of fluid product each time that they are actuated. The dispensing head 20 shown in the FIGURE is a nasal dispensing head and is used to actuate the pump 10 manually. Obviously, this invention is not limited to the example shown in the FIGURE, but different variant embodiments are possible. The pump 10 is designed to be assembled on a reservoir (not shown), in any known manner.

According to the invention, the device comprises dispensing detection means 30 that are adapted to detect when a product dose is dispensed. These detection means 30 are preferably adapted to output a signal to inform the user that a product dose was actually dispensed by the said pump. Thus, in the case of a dispensing pump in which the dose is so finely sprayed that the user does not realise that it has been dispensed, this invention prevents any risk of overdosage by informing the user that the dose has actually been dispensed. The user's information may be made in several different ways, for example using a display device. As a variant, sound or similar information means could be used to inform the user that the dose has been dispensed. Advantageously, the signal output by the dispensing detection means 30 could also be used to actuate a dose counter, even if this function is only optional and does not represent the main function of the said detection means.

As shown in the single FIGURE, the dispensing detection means 30 may be arranged in the expulsion channel 50 that connects the dispensing pump 10 to the spraying orifice 40 of the device. These detection means may include an expulsion detector 30 adapted to detect passage of the product in the said expulsion channel 50. For example, the expulsion detector 30 could be made in the form of a pressure sensor adapted to detect the pressure difference at the time that a product dose is sprayed. For example, the Nova Sensor NPC 100 sensor could be used in this application. The SM 5108 sensor made by Silicon Microstructure could also be used.

The detection means 30 and more particularly the expulsion detector may be connected to electronic means adapted to process the signal(s) output by the said detection means 30, firstly to inform the user that the dose has been dispensed, and secondly to implement other functions, for example such as actuation of a dose counter or indicator.

Therefore, this invention is applicable to devices comprising pumps, in other words dispensing devices operating without propellant gas and without active spraying means, such as piezoelectric or electrostatic spraying means. More particularly, this invention is applicable to pumps adapted to dispense very finely sprayed fluid product doses each time they are actuated, and prevent risks of overdosage related to the fact that a user who does not realise that a dose has been dispensed might decide to actuate the device again, with harmful consequence on his health.

Although this invention has been described with reference to one particular embodiment of it, it is clear that it is not limited by the example shown in the FIGURE. On the contrary, those skilled in the art could make useful modifications to it without going outside the scope of this invention as defined by the appended claims.

1. Fluid product spraying device comprising a fluid product dispensing pump (10) operating without propellant gas and without active spraying means, such as piezoelectric or electrostatic spraying means, and a spray head (20) to actuate the said pump (10) manually, characterised in that the said device comprises dispensing detection means (30) to detect that a product dose has been dispensed, the said detection means (30) being adapted to output a signal to inform the user that a dose of product has actually been dispensed by the said pump.

2. Device according to claim 1, in which the dispensing pump (10) is connected to a spraying orifice (40) through an expulsion channel (50), the said detection means (30) being provided in the said expulsion channel (50).

3. Device according to claim 2, in which the said detection means (30) comprise an expulsion detector (30) adapted to detect the passage of the product in the said expulsion channel (50).

4. Device according to claim 3, in which the said expulsion detector (30) comprises a pressure sensor adapted to detect the pressure difference at the time that a product dose is sprayed.

5. Device according to claim 1, in which the said detection means (30) are connected to electronic means to process signals output by the said detection means (30).

6. Device according to claim 1, in which the said detection means (30) are also adapted to increment and decrement a dose counter.

7. Device according to claim 1, in which the said device is a nasal spraying device, the said pump (10) being adapted to dispense the product so finely sprayed that this spraying is undetectable by the user, the said detection means (30) informing the user each time that a product dose has been dispensed.
